(19) United States
(12) Patent Application Publication
(10) Pub. No.: US 2012/0262354 A1
(43) Pub. Date: Oct. 18, 2012

(54) HIGH GAIN LOW PROFILE MULTI-BAND ANTENNA FOR WIRELESS COMMUNICATIONS

(76) Inventors: Ziming He, Irvine, CA (US); Ping Peng, Irvine, CA (US)

(21) Appl. No.: 13/450,447

(22) Filed: Apr. 18, 2012

Related U.S. Application Data
(60) Provisional application No. 61/476,713, filed on Apr. 18, 2011.

(51) Int. Cl. H01Q 13/10; H01Q 5/01; H01Q 19/00

(52) U.S. Cl. 343/767; 343/833

(57) ABSTRACT

The present invention is a low profile, wideband, high gain and high efficiency multi-band antenna with good return loss for wireless applications such as WLAN Access Point, ZigBee or WiMAX module, notebook computer, tablet computer and other mobile and portable devices applications and it can be used with any RF-front end circuitry that is working at 2.4-2.5 GHz, 3.2-3.5 GHz and 4.9-6.8 GHz frequency band. Moreover, the antenna assembly comprises a radiating element and two parasitic branches, all of which are sealed in a plastic housing with the feed pin and ground pin exposed for soldering onto a printed circuit board and thus it is easy for customers to assemble; they just need to solder the antenna pins on a printed circuit board and it will be operational. The L-shaped structure and the plastic housing make the antenna to be compact in size so it can be easily fabricated and employed in computers.

### REFERENCE TO RELATED APPLICATIONS

This patent application claims the benefit of U.S. Provisional Application No. 61/476,713 filed on Apr. 18, 2011, the disclosure of which is incorporated herein by reference in its entirety.

### BACKGROUND OF THE INVENTION

1. Field of the Invention

The present invention relates to the architecture of a compact, wideband, high gain and high efficiency tri-band antenna for wireless communications and the antenna can be used with any RF-front end circuitry that is working at 2.4-2.5 GHz, 3.2-3.5 GHz and 4.9-6.8 GHz frequency band.

2. Description of Related Art

Current wireless communication devices such as notebook computer, tablet computer etc. have an increasing demand for wide bandwidth, high gain multi-band antennas. However, in most cases the multi-band antenna design is difficult since it is hard to get enough bandwidth with good return loss for each frequency band (For example, cellular phone antenna often has a −5 dB return loss at the edges of operating frequency band even if matching circuit is applied).

Accordingly, there is a need in the art for a high gain wide bandwidth, multi-band antenna with excellent return loss characteristics across typical operating bandwidths. There is also a need in the art for an antenna capable of stable performance under various environmental conditions such that the likelihood of de-tuning resulting from nearby components and other objects placed in close proximity to the antenna is reduced.

### SUMMARY OF THE INVENTION

The primary object of the present invention is to provide a high gain, high efficiency, wideband and low profile multi-band antenna with good return loss for wireless applications such as WLAN Access Point, ZigBee or WiMAX module, notebook computer, tablet computer and other mobile and portable devices applications.

Aside from performance considerations, another object of the present invention is to provide an antenna that is cost effective so that the antenna can be manufactured and sold at a sufficiently low price for market acceptance.

Another object of the present invention is to provide a low profile antenna that is compact in size especially small in one dimension so it can be easily fabricated and embedded into a notebook computer and tablet computer.

Yet another object of the present invention is to provide an antenna that is easy for customers to put on a printed circuit board.

In an exemplary embodiment of the present invention, there is disclosed a low profile, wideband, high gain and high efficiency multi-band antenna with good return loss for wireless communications and it can be used with any RF-front end circuitry that is working at 2.4-2.5 GHz, 3.2-3.5 GHz and 4.9-6.8 GHz frequency band.

The antenna of the present invention comprises a radiating element, two parasitic branches, all of which are sealed in a housing and two pins (a feed pin and a ground pin) which are exposed outside the housing. It is easy for customers to assemble; they just need to solder the antenna pins on a printed circuit board and it will be operational. The L-shaped structure and the plastic housing make the antenna to be compact in size; The antenna's radiating element, parasitic branches and two pins are constructed of a single thin sheet of conductive material, preferably a copper sheet so it is cost effective. The housing may be made from PVC plastic and/or RF4.

Field-confined wideband antenna (FCWA) technology (see See US patent application Publication No. 20110128199, “Field-Confined Wideband Antenna for Radio Frequency Front End Integrated Circuits”, publication date Jun. 2, 2011) is used in the antenna design, and the antenna has compact size, wide bandwidth, excellent return loss, high gain and high radiation efficiency, and no matching circuit is needed. The antenna's radiating element and parasitic branches have slots specially arranged in such a way that a high frequency current loop can be formed, and the electromagnetic fields are confined in antenna body and the coupling between antenna and surrounding circuit components is significantly reduced, thus high peak gain and high radiation efficiency can be obtained. The distance between the feed pin and the ground pin is optimized to reduce the impedance of the high frequency current loop, thus improving the return loss.

Moreover the two parasitic branches, one is attached to the feed pin and another is attached to the ground pin, can increase the bandwidth. By adjusting the dimensions of the parasitic branches, the bandwidth can be increased.

Antenna return loss is better than −11 dB across the operating frequency band 2.4-2.49 GHz, better than −10 dB across the operating frequency band 3.2-3.5 GHz, and better than −11 dB across the operating frequency band 4.9-6.8 GHz, and no matching circuit is needed. The peak gain at 2.45 GHz is +4.24 dBi, at 3.35 GHz is +3.3 dBi, and at 5.4 GHz is +4.85 dBi. The radiation efficiency at 2.45 GHz, 3.35 GHz and 5.4 GHz are 98.4%, 97.4% and 97.6% respectively in HFSS simulation. Particularly, this antenna performance is very stable and will not be de-tuned easily by surrounding objects.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of an embodiment of an antenna assembly mounted on a printed circuit board.

FIG. 2 is a perspective view of an embodiment of an antenna assembly showing three dimensions of the antenna assembly.

FIG. 3 is a side view of the antenna structure of the FIG. 1.

FIG. 4 is a perspective view of the embodiment of the antenna assembly of FIG. 1 showing details of the antenna dimensions and a high frequency current loop.

FIG. 5 is a graph showing the simulated return loss of the dual-band antenna of the present invention.

FIG. 6 is a graph showing the simulated radiation and peak gain at 2.45 GHz.

FIG. 7 is a graph showing the simulated radiation pattern and peak gain at 3.25 GHz.

FIG. 8: a graph showing the simulated radiation and peak gain at 5.4 GHz.

### DESCRIPTION OF THE PREFERRED EMBODIMENT

The present invention provides a small, good performance and low cost antenna design. For wireless communication applications, there are generally three challenging requirement for embedded antenna: small size, good performance and low cost. The good performance means that the antenna should have wide bandwidth, good return loss, high gain and high radiation efficiency. To reach the aforementioned goal, Field-Confined Wideband Antenna Technology principle is used in the antenna design of the present invention (See US patent application Publication No. 20110128199, “Field-Confined Wideband Antenna for Radio Frequency Front End Integrated Circuits”, publication date Jun. 2, 2011, the disclosure of which is incorporated herein by reference).

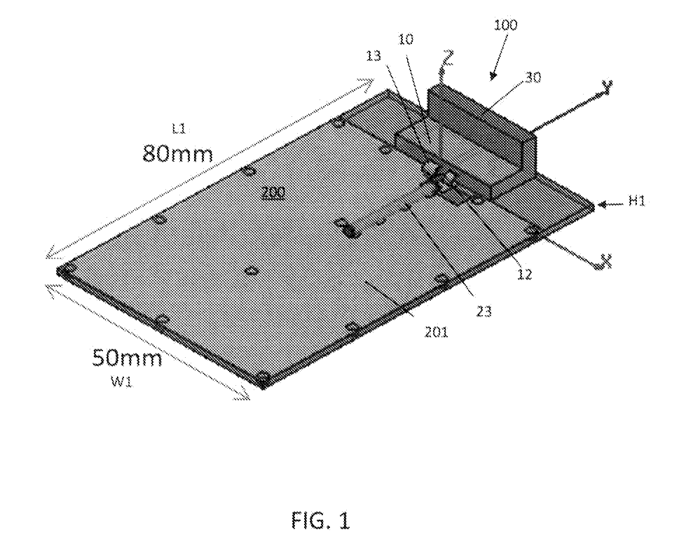

FIG. 1 shows a perspective view of an embodiment of the antenna assembly 100 mounted onto an exemplary printed circuit board 200. It will be appreciated that, while not otherwise depicted, additional components necessary for wireless communications may also be mounted to the printed circuit board 200 and electrically interconnected. The printed circuit board 200 has a planar, quadrilateral configuration having a top surface 201, a length given by L1, a width given by W1 and a height given by H1, as well as a lengthwise axis y, a widthwise axis x, and a vertical axis z. By way of example, the printed circuit board 200 may have dimensions of 80 mm×50 mm×1.6 mm (L1×W1×H1).

The antenna assembly 100 is mounted onto the printed circuit board with the two legs 12 and 13 soldered onto the printed circuit board 200. The antenna 10 is connected to RF front-end IC on the printed circuit board 200 either with a 50 ohm micro-strip line 23 or a 50 ohm coaxial cable, and no matching circuit is needed.

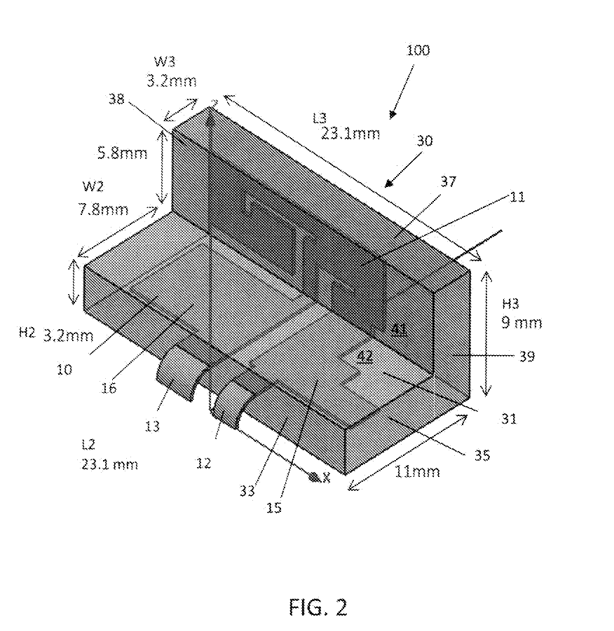

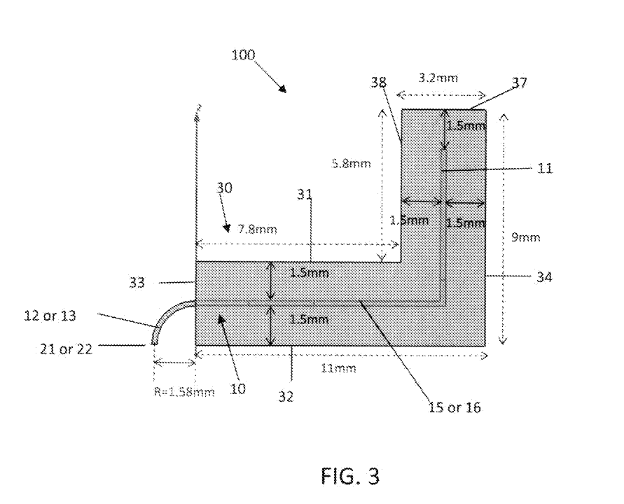

Referring to FIG. 2 and FIG. 3 there is disclosed a preferred embodiment of the antenna assembly 100. FIG. 2 shows a perspective view of the antenna assembly 100 illustrating the three dimensional structure and FIG. 3 shows a side view of the antenna assembly 100. The antenna assembly 100 comprises an antenna 10 sealed in a plastic housing 30. The antenna 10 may be made of any conductive material, preferably a copper sheet which has a thickness of approximately 0.2 mm. The antenna 10 comprises a radiating element 11, two parasitic branches 14, 15 which are perpendicular to the radiating element 11, and two parallel “legs”, one is a feed pin 12 and the other is a ground pin 13; both legs extending from the front of the parasitic branches are in an angularly offset relationship to the parasitic branches 14, 15.

The plastic housing 30 has two orthogonal rectangular configurations forming an L-shape. The first rectangular configuration 41 has a first top 31, a bottom 32 (not observable in FIG. 2), a first front 33, and a two opposed lateral sides 35, and 36 (not observable in FIG. 2). The second rectangular configuration 42 has a second top 37, a second front 38, a back 34 (not observable in FIG. 2) and two opposed lateral sides 39 and 40 (not observable in FIG. 2). Also shown in FIG. 2 are specific dimensional parameters which may be varied to optimize antenna performance.

The three dimensional parameters length L2, width W2, and height H2 of the first rectangular configuration 41 and length L3, W3, and H3 of the second rectangular configuration 42 of the plastic housing 30 and the dimensions of the antenna radiating element 11 and two legs 12 and 13 are selected for the desired operating frequency of the antenna 100. The antenna bandwidth may be adjusted by changing the dimensions of the antenna radiating element 11 and two legs 12 and 13 and the height that the antenna radiating element 11 is located on the printed circuit board 200. One specific example of values of such parameters according to one preferred embodiment of the present invention will be described below.

In the preferred embodiment as shown in FIGS. 1-3, the L2, W2 and H2 of the first rectangular configuration 41 are approximately 23.1 mm, 7.8 mm and 3.2 mm respectively. The L3, W3 and H3 of the second rectangular configuration 42 are 23.1 mm, 3.2 mm, and 9 mm.

The antenna's parasitic branches 14, 15 of the antenna 10 are located horizontally in the middle of the first rectangular configuration 41 of the housing 30 where it is 1.5 mm away from the first top 31, and bottom 32 of the plastic housing 30. The radiating element 11 is located in the middle of the second rectangular configuration 42 of the housing 30 where it is 1.5 mm away from the second top 37, second front 38 and back 34 of the plastic housing 30. Both of the feed pin 12 and ground pin 13 extend from the parasitic branches 14, 15 through the front side 33 of the housing and bent down in a curve shape along the front side 31 of the housing. The bottom end of feed pin 21 and bottom end of ground pin 22 (not observable) are flush with the bottom 32 and are about 1.58 mm away from the front 33 of the housing. That means the height of the antenna parasitic branches 14, 15 are approximately 1.5 mm above the printed circuit board 200. The housing 30 is used to cover and support antenna, and can help to reduce the antenna dimensions. The two feed pin 12 and ground pin 13 are designed to be exposed outside the plastic housing 30 so that the antenna can be easily installed on a printed circuit board. The customer only needs to solder the two pins 12 and 13 on the printed circuit board 200 for operation. The feed pins 12 is designed to electrically couple the radiating element 11 to an RF feeding port 24 which receives the RF signal for transmission over a micro-strip line 23. The ground pin 13 electrically couples the radiating element 11 to the grounding island on the printed circuit board. The antenna 10 of the present invention can be connected to RF front-end IC 25 either with a 50 ohm micro-strip line or a 50 ohm coaxial cable, and no matching circuit is needed. The housing 30 is made from polyvinyl chloride (PVC) plastic in the preferred embodiment, but it may be made from other materials including but not limited to FR4 which is a composite material composed of woven fiberglass cloth with an epoxy resin binder that is flame resistant.

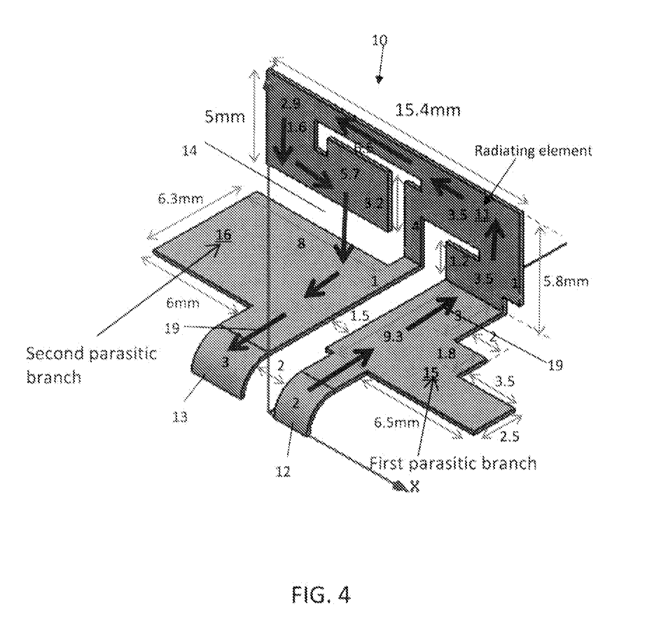

FIG. 4 shows a perspective view of an antenna 10 illustrating the details of the antenna element layout. The antenna 10, made from a single thin sheet of conductive material, such as a copper sheet, comprises a radiating element 11, parasitic branches 14, 15 which are integral and orthogonal to the radiating element, and two pins 12, 13 which extend from the parasitic branches and bent down in a curve shape. The specific dimensional parameters of the antenna including dimensions of radiating element, parasitic branches, feed and ground pins may be adjusted to optimize the antenna performance for a particular application.

As mentioned earlier, Field-Confined Wideband Antenna Technology principle is used in the antenna design (see US patent application Publication No. 20110128199, “Field-Confined Wideband Antenna for Radio Frequency Front End Integrated Circuits”, publication date Jun. 2, 2011, the disclosure of which is incorporated herein by reference). Slots on the antenna are used to confine the electric field so that the antenna has less interaction with other components around it and thus has good isolation from other components near it. The slot length can be selected for a specific application. Depending on the application, the slot direction and location may be selected to optimize performance. The confining slot 14 on the radiating element 11 is arranged in such a way that a high frequency current loop 19 can be formed (FIG. 4), and the electromagnetic fields are confined in antenna body and the coupling between antenna and surrounding circuit components is significantly reduced, thus high peak gain and high radiation efficiency can be obtained.

The high frequency current loop 19 is formed from the feed pin 12 which is fed by an external source via an RF feeding port, to the radiating element 11, around the confining slot 14 and, to the ground pin 13. The feed pin 12 is the origin of the high frequency loop 19 while the ground pin 13 is its terminus. The impedance of the high frequency loop 19, and hence the return loss, is dependent upon the dimensions between the feed pin 12 and the ground pin 13. Thus, by adjusting the distance between the feed pin 12 and ground pin 13, it is possible to change the impedance of the loop and improve the return loss. Furthermore, the length of the high frequency loop 19, and by definition, the dimensions of the confining slot 14, correspond to the resonant frequencies of the radiating element 11. Hence, the multi-band features and the center frequency of the antenna can be obtained by changing the length of the antenna radiating element 11 and adjusting the length of the slots. The antenna bandwidth can also be adjusted by changing the height and the width of the antenna radiating element 11.

The two parasitic branches 14 and 15 are added to improve the bandwidth of the antenna. The first parasitic branch 14 is attached to the feed pin 12 and the second parasitic branch 15 is attached to the ground pin 13. By adjusting the dimensions of the parasitic branches, the bandwidth of the antenna can be increased significantly. Moreover, due to the small coupling between the antenna and the surrounding components, the antenna performance is very stable and will not be de-tuned easily.

The tri-band antenna of the present invention with operating frequency of 2.4 to 2.485 GHz, 3.1 to 3.5 GHz and 4.9 to 5.9 GHz bands was designed and simulated with HFSS. The dimensions of the antenna of the present invention have been optimized until excellent performance was obtained in simulation. The optimized dimensions of the antenna including dimensions for the radiating elements 18, the feed and ground pins 12 and 13, the parasitic branches 15 and 16, and the slot 14 are illustrated in FIG. 4. The optimized dimensions of the radiating element 11 are about 15.4 mm×5.8 mm×0.2 mm. The optimized widths of the feed pin 12 and ground pin 13 are approximately 2 mm and 3 mm, respectively. The optimized distance between the feed pin 12 and ground pin 13 is 2 mm. The overall dimensions for the second parasitic branch 16 are about 8 mm×6.3 mm×0.2 mm. The first parasitic branch 15 is about 9 mm×9 mm×0.2 mm with multiple cut outs on the right side of the branch.

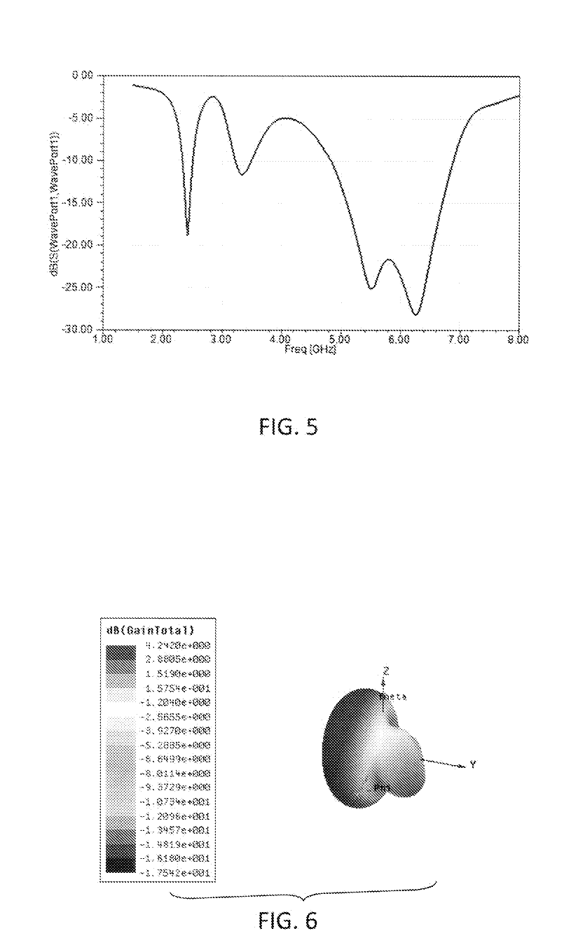

With the special architecture shown in above figures, the antenna assembly 100 of the present invention has compact dimensions, ultra-wide bandwidth, excellent return loss, high gain, high efficiency and weak coupling with surrounding circuit components. Thus a superior performance multi-band antenna is obtained. The performance of this tri-band antenna assembly (2.4 to 2.485 GHz, 3.2 to 3.5 GHz and 4.9 to 6.8 GHz operating bands) has been simulated with high frequency structural simulator (HFSS) for operation in 2.45 GHz, 3.25 GHz and 5.4 GHz operating frequencies. The antenna dimensions have been optimized until excellent performance was obtained in simulation. The antenna was built with 0.2 mm copper sheet, and the antenna housing was built with PVC plastic. The simulated return loss is given in FIG. 5. Antenna return loss is better than −11 dB across the operating frequency band 2.4-2.49 GHz, better than −10 dB across the 3.2-35 GHz frequency band, and better than −11 dB across the operating frequency band 4.8-6.8 GHz, and no matching circuit is needed.

The simulated 3D radiation pattern and peak gain at 2.45 GHz is shown in FIG. 6. The radiation pattern is Omni-directional in XZ plane, and the peak gain is +4.24 dBi. The simulated radiation efficiency is 98.4% at 2.45 GHz.

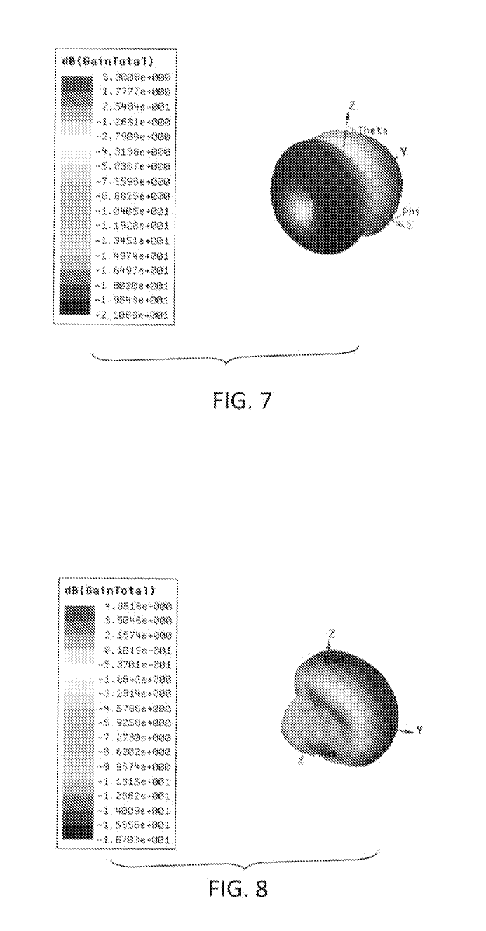

The simulated 3D radiation pattern and peak gain at 3.25 GHz is shown in FIG. 7. The radiation pattern is Omni-directional in XZ plane, and the peak gain is +3.3 dBi. The simulated radiation efficiency is 97.4% at 3.35 GHz.

The simulated 3D radiation pattern and peak gain at 5.4 GHz is shown in FIG. 8. The radiation pattern is approximately Omni-directional in YZ plane. The peak gain is +4.85 dBi at 5.4 GHz and the simulated radiation efficiency is 97.6% at 5.4 GHz.

From above results it is obvious that due to the special structure of the antenna, the current and electromagnetic fields are confined in antenna body, thus the antenna has weak coupling with surrounding circuit components and small loss, and high gain and high efficiency can be obtained. The narrow shape can be easily fabricated and embedded into a notebook computer and tablet computer.

Current illustration is one embodiment only. Other embodiment including but not limited to printed circuit board (PCB), metal plated plastic and other sheet metal configuration.

The invented architecture and principle can be applied to other frequency bands and other applications.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A high gain low profile multi-band antenna assembly for wireless communications, the antenna assembly comprising:
a housing having a first and a second rectangular configurations which are orthogonal to each other forming an L-shape, the first rectangular configuration having a first top, a bottom, a first front, and a two opposed lateral sides, the second rectangular configuration having a second top, a second front, a back and two opposed lateral sides and;
an antenna having a radiating element, two parasitic branches which are perpendicular to the radiating element, and two parallel legs, one is a feed pin and the other is a ground pin, both of which extend from the parasitic branches are in an angularly offset relationship to the parasitic branches;
wherein the radiating element, parasitic branches, feed pin and ground pin are constructed of one single thin sheet of conductive material, the radiating element being placed in the middle of the second rectangular configuration of the housing, the parasitic branches being horizontally placed in the middle of the first rectangular configuration of the housing, and the feed pin and ground pin extending through the front side of the housing and bent down in a curve shape along the front side of the housing with their bottom ends flush with the bottom of the housing, the L-shape structure making the antenna to be compact;

2. The antenna assembly of claim 1 is designed to be mountable onto a printed circuit board, metal plated plastic or other sheet metal configuration.

3. The antenna assembly of claim 1, wherein the housing can be made from polyvinyl chloride (PVC) plastic or RF-4 to help reduce the antenna's dimensions.

4. The antenna assembly of claim 1, wherein the thin sheet of conductive material is preferably a copper sheet of approximately 0.2 mm thick.

5. The antenna assembly of claim 1, wherein the first rectangular configuration is preferably about 23.1 mm, 7.8 mm and 3.2 mm and the second rectangular configuration is preferably about 23.1 mm, 3.2 mm, and 9 mm.

6. The antenna assembly of claim 5, wherein the antenna radiating element is preferably 1.5 mm away from the second top, the second front, and the back of the housing, and the feed pin and the ground pin are preferably 2 mm apart.

7. The antenna assembly of claim 6, wherein the antenna parasitic branches are preferably 1.5 mm away from the first top, and the bottom of the housing.

8. The antenna assembly of claim 1 further comprising a first slot on the radiating element defining a first high frequency current loop which is originated from the feed pin to the radiating element around the slot and to the ground pin, the high frequency current loop confining current and electromagnetic fields on the antenna.

9. The antenna assembly of claim 8, wherein a location and dimensions of the slot are selected and optimized in such a way that the antenna has weak coupling with surrounding components, good isolation from the surrounding components, high gain and efficiency and is not easily de-tuned when a component is approaching it.

10. The antenna assembly of claim 8, wherein the antenna's and slot's dimensions can be adjusted to change the bandwidth of the antenna.

11. The antenna assembly of claim 8, wherein the slot helps to reduce the antenna's dimensions.

12. The antenna assembly of claim 8 wherein the grounding pin is arranged in such a way that it is close to the end of the high frequency current loop.

13. The antenna assembly of claim 1 wherein the first parasitic branch which is attached on the feed pin and the second parasitic branch which is attached on the ground pin, wherein the dimensions of the parasitic branches can be adjusted to increase the bandwidth of the antenna.

14. The antenna assembly of claim 13 wherein the antenna provides tri-band operation with operating frequencies determined by the dimensions of the antenna and slot.
